(19) United States
(12) Patent Application Publication
(10) Pub. No.: US 2017/0029745 A1
(43) Pub. Date: Feb. 2, 2017

(54) ENZYME CLEANING AND PROTECTING COMPOSITIONS AND METHODS

(71) Applicant: 3M INNOVATIVE PROPERTIES COMPANY, St. Paul, MN (US)

(72) Inventors: Masayuki NAKAMURA, Woodbury, MN (US); Diane L. EMSLANDER, Stillwater, MN (US); Stewart H. CORN, St. Paul, MN (US); Nicole M. GRYSKA, Woodbury, MN (US)

(21) Appl. No.: 15/038,771

(22) PCT Filed: Dec. 3, 2014
(86) PCT No.: PCT/US2014/068286

§ 371 Date: May 24, 2016

Related U.S. Application Data
(60) Provisional application No. 61/911,682, filed on Dec. 4, 2013.

(51) Int. Cl. C11D 3/386; C11D 1/83; C11D 1/90; C11D 1/22; C11D 3/37; C11D 3/00

(52) U.S. Cl. CPC C11D 3/38618; C11D 3/3765; C11D 3/0036; C11D 1/90; C11D 1/22; C11D 3/378; C11D 1/83; C11D 3/38627; C11D 3/3773

(57) ABSTRACT

An aqueous enzyme cleaning and protecting composition that includes: water; a protease; a surfactant selected from an anionic surfactant, a nonionic surfactant, an amphoteric surfactant, and a combination thereof; and a (meth)acrylic acid polymer component that is non-emulsifying; wherein the composition demonstrates protease activity.

### BACKGROUND

Cleaning reagents containing enzymes have gained popularity in the consumer market. Laundry detergents and carpet/floor cleaners containing multiple enzymes are two successful examples of adapting enzyme technology. Enzymatic cleaners for pet care applications are particularly popular.

Besides the cleaning performance to remove the mess/stain, anti-resoiling is another important performance measure. Resoiling is a phenomenon that occurs when previously cleaned spots attract dirt because residual dried, but sticky, surfactant remains on the carpet. Current enzyme cleaners have poor anti-resoiling performance (i.e., resoiling occurs).

Compounds added to cleaners, e.g., such as compounds known for their superior anti-resoiling properties, can reduce the cleaning capability of enzyme cleaners. It is believed that this is due, at least in part, to a reduction in enzyme activity.

### SUMMARY OF THE DISCLOSURE

Thus, there is a need for an enzyme cleaner concept that can achieve high performance on (1) textile cleaning, (2) retained enzyme activities, and/or (3) anti-resoiling.

The present disclosure provides enzyme cleaning and protecting compositions that are particularly useful for cleaning textiles, such as carpets and upholstery. The compositions include one or more enzymes, one or more surfactants, and a non-emulsifying (meth)acrylic acid polymer component. Significantly, compositions of the present disclosure possess a good balance of cleaning ability, enzyme activity, and/or anti-resoiling ability (i.e., protecting ability).

In one embodiment, the present disclosure provides an aqueous enzyme cleaning and protecting composition that includes: water; a protease; a surfactant selected from an anionic surfactant, a nonionic surfactant, an amphoteric surfactant, and a combination thereof; and a (meth)acrylic acid polymer component; wherein the composition demonstrates protease activity.

In certain embodiments, compositions of the present disclosure include at least two different enzymes, in particular, two different classes of enzymes. Certain compositions include a protease and an amylase. If an amylase is present, the composition demonstrates amylase activity.

In certain embodiments, the present disclosure provides an aqueous enzyme cleaning and protecting composition that includes: water; one or more enzymes including a protease and an amylase; one or more surfactants selected from an anionic surfactant, a nonionic surfactant, an amphoteric surfactant, and a combination thereof; and a (meth)acrylic acid polymer component that includes a polymer having monomeric units derived from a (meth)acrylic acid monomer and one or more ethylenically unsaturated comonomers; wherein the composition demonstrates protease activity; and wherein the composition demonstrates amylase activity.

In certain embodiments, the (meth)acrylic acid polymer component does not include an emulsifying ability, i.e., it is non-emulsifying, as determined by the Emulsification Test for Polymer Material (as described in the Examples Section). In certain embodiments, the (meth)acrylic acid polymer of the (meth)acrylic acid polymer component does not include any crosslinking. In certain embodiments, the (meth)acrylic acid polymer of the (meth)acrylic acid polymer component has a weight average molecular weight of less than 1 million.

In certain embodiments, the present disclosure provides a method of cleaning and protecting a soiled textile. The method includes applying a composition of the present disclosure, and optionally, after a period of time, removing the composition from the textile.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of about 20° C. to about 25° C. or about 22° C. to about 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### DETAILED DESCRIPTION OF ILLUSTRATIVE EMBODIMENTS

The present disclosure provides aqueous enzyme cleaning and protecting compositions that are particularly useful for cleaning textiles, such as carpets and upholstery. The compositions include one or more enzymes, one or more surfactants, and a (meth)acrylic acid polymer component.

In one embodiment, the present disclosure provides an aqueous enzyme cleaning and protecting composition that includes: water; a protease; a surfactant selected from an anionic surfactant, a nonionic surfactant, an amphoteric surfactant, and a combination thereof; and a (meth)acrylic acid polymer component; wherein the composition demonstrates protease activity.

In certain embodiments, compositions of the present disclosure include at least two different enzymes, in particular, two different classes of enzymes. Certain compositions include a protease and an amylase. Certain compositions include a protease, an amylase, and a lipase.

Significantly, compositions of the present disclosure possess a good balance of enzyme activity, cleaning ability, and anti-resoiling ability (i.e., protecting ability).

Compositions of the present disclosure “demonstrate enzyme activity” (e.g., protease, amylase, and/or lipase), preferably, they “demonstrate protease activity.” In certain embodiments, the compositions demonstrate protease and amylase activity. In certain embodiments, the compositions demonstrate protease and lipase activity. In certain embodiments, the compositions demonstrate protease, amylase, and lipase activity. By this it is meant that the activity of an enzyme present in a composition of the present disclosure is not completely destroyed by the other components present in the composition (although there may be some decomposition of enzyme activity by one or more of the other components in the compositions). This would be a qualitative assay, indicating the presence of one or more active enzymes.

Enzyme activity for compositions of the present disclosure may be measured by a variety of known assays. For example, the protease activity of a cleaning formulation suspected of having protease activity can be determined in a variety of protease assays. A specific example of a suitable enzyme assay is provided in the Examples section (the Enzyme Activity Test is provided specific for each type of enzyme). This specific example should not be considered a limiting example of a suitable assay.

Compositions of the present disclosure are typically evaluated for protease activity, and (if present) amylase activity and/or lipase activity, relative to a corresponding enzyme solution as a “control.” In evaluating the enzyme activity of a known test formulation, the “corresponding enzyme solution” is a “control” that contains the same enzyme(s) and same level of enzyme concentration (diluted with distilled water) as in the corresponding known test formulation. The enzyme activity is reported as a relative enzyme activity as a percentage of the enzyme activity of a corresponding enzyme solution (i.e., the “control” for a composition of the present disclosure with a known amount of enzyme).

In evaluating the enzyme activity of an unknown formulation (i.e., one with an enzyme but in an unknown amount), a “reference enzyme solution” can serve as a “reference sample” that contains a set of reference enzymes at a selected level of enzyme concentration (diluted with distilled water). This is referred to herein as the “control” for an unknown sample. The enzyme activity for the unknown formulation is reported as a relative enzyme activity as a percentage of the enzyme activity of the reference enzyme solution (i.e., the reference sample or “control” for an unknown formulation).

In certain embodiments, a composition of the present disclosure that includes a protease preferably demonstrates a protease activity of at least 10% of a control, or at least 15% of a control, or at least 20% of a control, or at least 30% of a control (i.e., a “corresponding enzyme solution” for a test formulation containing a known amount of a protease or a “reference enzyme solution” for an unknown formulation with a protease in an unknown amount). A composition of the present disclosure that includes an amylase preferably demonstrates an amylase activity of at least 10% of a control, or at least 15% of a control, or at least 20% of a control, or at least 30% of a control (i.e., a “corresponding enzyme solution” for a test formulation containing a known amount of an amylase or a “reference enzyme solution” for an unknown formulation with an amylase in an unknown amount). A composition of the present disclosure that includes a lipase preferably demonstrates a lipase activity of at least 10% of a control, or at least 15% of a control, or at least 20% of a control, or at least 30% of a control (i.e., a “corresponding enzyme solution” for a test formulation containing a known amount of a lipase or a “reference enzyme solution” for an unknown formulation with a lipase in an unknown amount).

Cleaning ability may be measured by the Textile Cleaning Test (described in the Examples Section) and reported as a Delta E value, where Delta E represents the difference between the color of the virgin textile and the stained and cleaned textile. A small Delta E is therefore desired. Compositions of the present disclosure preferably possess a cleaning ability represented by a Delta E value of no greater than 10, or no greater than 8, or no greater than 6, or no greater than 4. It should be understood that Delta E values for cleaning may vary depending on the textile color, fabric type, whether the textile has been initially treated with a fluorochemical treatment, type of stain, cleaning method, amount of cleaner, etc.

Anti-resoiling (i.e., protecting ability) may be measured by Resoiling Test (described in the Examples Section) and reported as a Delta E value, where Delta E represents the difference between the color of the virgin textile and the cleaned and resoiled textile. A small delta E is therefore desired. Compositions of the present disclosure preferably possess an anti-resoiling ability (after 12 days of testing) represented by a Delta E value of no greater than 10, or no greater than 8, or no greater than 6. Compositions of the present disclosure preferably possess an anti-resoiling ability (after 4 days of testing) represented by a Delta E value of no greater than 10, or no greater than 8, or no greater than 6, or no greater than 4, or no greater than 2. It should be understood that the Delta E values for resoiling may vary depending on the textile color, textile type, whether the textile has been initially treated with a fluorochemical treatment, amount of cleaner, the amount of foot traffic (roughly correlated with the day count), weather (wet/snowy weather gives much more rapid soiling), etc.

Thus, as used herein, a composition that demonstrates “cleaning ability and protecting ability” preferably refers to a composition that possesses a cleaning ability (as measured by the Textile Cleaning Test) represented by a Delta E value of no greater than 10, and a protecting ability (i.e., an anti-resoiling ability as measured by the Resoiling Test after 12 days of testing) represented by a Delta E value of no greater than 10.

### Enzymes

Compositions of the present disclosure include at least one enzyme. Such enzymes include at least one protease, lipase, or amylase. In certain embodiments, the enzyme is a protease. The purpose of the enzyme is to break down adherent materials typically found in bodily fluids, such as blood, urine, vomit, feces, into forms that are readily dispersed into a water-based wash solution. Certain embodiments include a mixture of two or more enzymes, which may be of the same class of enzyme or of different classes of enzymes.

A wide variety of enzymes or mixture of enzymes, from a wide variety of sources, may be employed in the compositions of the present disclosure, provided that the selected enzyme is compatible with the other components of the composition. By “compatible” it is meant that the one or more enzymes are not completely inactivated by one or more of the other components of the composition.

While enzymes may be obtained commercially in a solid or liquid form, the liquid form is preferred for greater convenience in dispersing the enzyme(s) during preparation of the compositions of the disclosure and for complete water dissolution of the enzyme(s).

Preferred enzymes are stable in an aqueous solution having a pH of 5 to 8, and retain sufficient activity per gram of enzyme protein when combined with the other components of the composition to economically solubilize and remove proteinaceous, carbohydrate-based, and/or lipid-based materials from textiles.

In certain embodiments, at least two different enzymes are included in compositions of the present disclosure. In certain embodiments, at least one enzyme from each of two different classes of enzymes (e.g., one protease and one amylase or one protease and one lipase) is included in compositions of the present disclosure. In certain embodiments, at least one enzyme from each of three different classes of enzymes (e.g., one protease, one amylase, and one lipase) is included in compositions of the present disclosure.

Suitable protease enzymes are, for example, the enzymes obtained from Bacillus subtilis, Bacillus licheniformis, and Streptomyces griseus. Suitable protease enzymes are one or more of the commercially available serine endoproteases. These enzymes preferably cleave protein links on the carboxyl side of hydrophobic amino acid residues, but are capable of cleaving most peptide links. They convert their substrates into small fragments that are readily dissolved or dispersed into a wash solution.

Exemplary proteases are commercially available under the trade names EVERLASE (e.g., EVERLASE 16L), LIQUANASE, SAVINASE (e.g., SAVINASE 16L), or ESPERASE (all available from Novozymes, Franklinton, N.C.), as well as PURAFECT (e.g., PURAFECT Prime L, PURAFECT L, or PURAFECT Ox) (available from Genencor, Rochester, N.Y.). An exemplary protease is that from Bacillus sp. available from Sigma-Aldrich (St. Louis, Mo.), which is equivalent to SAVINASE 16L (Novozymes, Franklinton, N.C.).

Suitable lipase enzymes are, for example, the enzymes obtained from Thermomyces lanuginosus, Candida antarctica, and Rhizomucor miehei. Suitable lipase enzymes are one or more of the commercially available recombinant lipase enzymes. These enzymes preferably cleave the lipids by hydrolyzing ester bonds. They convert their substrates into small fragments that are readily dissolved or dispersed into a wash solution.

Exemplary lipases are commercially available under the trade names LIPEX or LIPOLASE (e.g., LIPOLASE 100L), CALB (e.g. CALB L), or PALATASE (e.g., Palatase 20000L) (available from Novozymes). An example of a lipase is that from Thermomyces lanuginosus available from Sigma-Aldrich (St. Louise, Mo.), which is equivalent to LIPOLASE 100L (Novozymes, Franklinton, N.C.).

Suitable amylase enzymes are, for example, the enzymes obtained from barley malt and certain animal glandular tissues. Preferred types of amylases include those which are referred to as alpha-amylases, beta-amylases, iso-amylases, pullulanases, maltogenic amylases, amyloglucosidases, and glucoamylases, as well as other amylase enzymes, including endo- and exo-active amylases. Such amylases are commercially available under the tradenames PURASTAR (e.g., PURASTAR ST or PURASTAR HP AmL) (available from Genencor), as well as STAINZYME, DURAMYL, or TERMAMYL (e.g., TERMAMYL 120 or TERMAMYL Ultra) (all available from Novozymes). An exemplary amylase is Alpha-Amylase from Bacillus Licheniformis Type XII-A available from Sigma-Aldrich (St. Louis, Mo.), which is equivalent to TERMAMYL 120 (Novozymes).

In certain embodiments, compositions of the present disclosure include at least 0.05 wt-%, of each of at least one enzyme product solution, in liquid form as supplied, based on the total weight of the composition. In certain embodiments, compositions of the present disclosure include up to 10.0 wt-%, of each of at least one enzyme product solution, in liquid form as supplied, based on the total weight of the composition.

### Surfactants

Any of a wide variety of surfactants (e.g., anionic, nonionic, amphoteric) may be used in the compositions of the present disclosure, so long as the surfactant is compatible with the other components of the composition, does not inactivate the enzyme(s) completely, and provides detergency desired to clean a soiled substrate. Mixtures of surfactants may be used in the compositions of the present disclosure. Such mixtures may include different surfactants of the same class (e.g., two anionic surfactants), or mixtures of different classes (e.g., anionic and nonionic surfactants).

Anionic Surfactants.

The anionic surfactants can contain one or two hydrophobic groups and one or two water-solubilizing anionic groups. The hydrophobic group(s) should be large enough to make the surfactant sufficiently surface active, i.e., the total number of carbon atoms in all hydrophobic groups can preferably be at least 8. The hydrophobic group is often an alkyl group, aryl group, or combination thereof. Examples of suitable hydrophobic groups include straight and branched octyl, decyl, lauryl (i.e., dodecyl), myristyl (i.e., tetradecyl), cetyl (i.e., hexadecyl), stearyl (i.e., octadecyl), dodecylbenzyl, naphthyl, xylyl, and diphenyl. Heteroatom-containing moieties may be present in the hydrophobic group, including, e.g., ester, amide, and ether groups. For example, some hydrophobic groups include an alkyl group connected to an ether or to a polyether segment. When more than one hydrophobic group is present, the length of the chain may be relatively short (e.g., two n-butyl groups).

The water-solubilizing anionic group can preferably be sufficiently polar to effectively solubilize the surfactant in water to allow formation of micelles. Suitable water-solubilizing anionic groups include, e.g., sulfonate, sulfate, sulfosuccinate, and carboxylate. The positive counterion(s) for the anionic group may be one or more alkali metal ions (e.g., Na⁺, K⁺, or Li⁺), alkaline earth metal ions (e.g., Mg⁺⁺ or Ca⁺⁺), or ammonium ion (e.g., NH₄⁺, tetraalkyl ammonium ion, or protonated amine such as protonated triethanolamine (e.g., triethanolamine stearate has a protonated triethanolamine)). Optionally, the water-solubilizing anionic group may also contain a polyoxyethylene group of 1-15 monomeric units located between the hydrophobic group and the charged ionic group to form an ether sulfate, ether sulfonate or ether carboxylate group.

Preferred anionic surfactants include alkyl benzene sulfonates, alkyl ether sulfates, sulfonates, sulfosuccinates, and alkyl sulfates. Examples of suitable anionic surfactants include sodium lauryl sulfate, sodium myristyl sulfate, sodium lauryl ether (2) sulfate (i.e., C₁₂H₂₅(OCH₂CH₂)₂OSO₃⁻Na⁺), ammonium lauryl ether sulfate (i.e., ammonium laureth sulfate or C₁₂H₂₅(OCH₂CH₂)₃OSO₃⁻ NH₄⁺), sodium decyl sulfate, ammonium myristyl ether sulfate, sodium nonylphenol polyglycol ether (15) sulfate, sodium C6-C8 α-olefin sulfonate, sodium dodecylbenzene sulfonate, sodium xylene sulfonate, sodium naphthyl sulfonate, sodium dihexyl sulfosuccinate, disodium lauryl ether sulfosuccinate (i.e., disodium laureth sulfosuccinate), sodium laurate, sodium stearate, sodium ether (5) stearate, potassium ricinoleate (potassium 12-hydroxy-9-octadecanoate), sodium myristoyl sarcosine, and sodium N-methyl-N-oleyl taurate. A preferred surfactant is sodium xylene sulfonate. Such anionic surfactants are commercially available from many suppliers (e.g., Stepan Company), many of whom are listed in the McCutcheon's Emulsifiers & Detergents directory, North America or International Editions (1996).

Exemplary anionic surfactants include sodium dodecylbenzene sulfonate (an alkyl benzene sulfonate type) available under the trade designation “BIOSOFT D40”, ammonium laureth sulfate (an alkyl ether sulfate type) available under the trade designation “STEOL CA-330”, sodium xylene sulfonate (a sulfonate type) available under the trade designation “STEPANATE SXS”, disodium laureth sulfosuccinate (a sulfosuccinate type) available under the trade designation “STEPANMILD SL3-BA”, and sodium lauryl sulfate (an alkyl sulfate type) available under the trade designation “STEPANOL WA-EXTRA”, all from Stepan Company, Northfield, Ill.

Nonionic Surfactants. Examples of nonionic synthetic detergents or surfactants are condensation products of ethylene oxide, propylene oxide, and/or butyleneoxide with (C8-C18)alkylphenols, (C8-C18)primary or secondary aliphatic alcohols, or (C8-C18)fatty acid amides. Other examples of nonionics include, e.g., tertiary amine oxides with one (C8-C18)alkyl chain and two (C1-C3)alkyl chains. The average number of moles of ethylene oxide and/or propylene oxide present in the above various nonionics varies from 1-30; mixtures of nonionics, including mixtures of nonionics with a lower and a higher degree of alkoxylation, may also be used. Other examples of nonionic surfactants are those derived from sugars and fatty alcohols, for example, alkyl polyglucosides.

Examples of suitable nonionic surfactants include C8-C16 polyglucosides (e.g., such as the C8-C16 polyglucoside available from BASF (Florham Park, N.J.) under the trade designation “GLUCOPON 425N”), and C12-C13 alcohol ethoxylates (e.g., such as the C12-C13 linear alcohol with 6.5 moles of ethoxylation (EO=6.5) of the alcohol ethoxylate type available from Stepan Company, Northfield, Ill., under the trade designation “BIOSOFT N23-6.5”).

Amphoteric Surfactants.

Suitable amphoteric (i.e., zwitterionic) surfactants (i.e., detergents) include alkylamido betaines, N-alkylamino acids, sulphobetaines, and condensation products of fatty acids with protein hydrolysates. An example of a suitable amphoteric surfactant is cocamidopropyl betaine (an alkyamidopropyl betaine) such as that available from Stepan Company, Northfield, Ill., under the trade designation “AMPHOSOL CA”.

Mixtures of the various types of surfactants may be used if desired.

In certain embodiments, the surfactant (in terms of surfactant solids) can generally be present in a composition of the present disclosure in an amount of at least 0.1 wt-%, or at least 0.2 wt-%, or at least 0.3 wt-%, or at least 0.4 wt-%, or at least 0.5 wt-%, based on the total weight of the composition. In certain embodiments, the surfactant (in terms of surfactant solids) can generally be present in a composition of the present disclosure in an amount of up to 5 wt-%, or up to 4 wt-%, or up to 3 wt-%, or up to 2 wt-%, or up to 1 wt-%, based on the total weight of the composition.

The lower the amount of surfactant, the less resoiling problems and the less the amount of (meth)acrylic acid polymer component needed to “offset” the surfactant (i.e., to counteract the tendency for residual surfactant left on the carpet to attract soil because it remains tacky). In the compositions of the present disclosure, a (meth)acrylic acid polymer component to surfactant solids ratio within a range of 1.4:1 to 2.5:1 (solids only) is preferred. For certain surfactants (e.g., ethoxylated alcohols), a higher ratio (e.g., a 7.1:1 (meth)acrylic acid polymer component to surfactant solids ratio) may be necessary to obtain a useful (i.e., non-resoiling) cleaner. For certain surfactants, a lower ratio (e.g., a 0.5:1 (meth)acrylic acid polymer component to surfactant solids ratio) may be necessary to obtain a more cost-effective cleaner.

### (Meth)Acrylic Acid Polymer Component

The (meth)acrylic acid polymer component (i.e., (meth)acrylic acid-containing polymer component) is believed to be primarily responsible for the ability of the compositions of the present disclosure to protect the substrate (e.g., carpet or upholstery) from restaining or resoiling. In certain embodiments, the (meth)acrylic acid polymer component can include a homopolymer of (meth)acrylic acid, or a copolymer comprising monomeric units derived from monomers including (meth)acrylic acid and one or more ethylenically unsaturated comonomers, mixtures of such homopolymer and copolymer(s), or a mixture that includes “comonomers” that may not be copolymerized. In this context, the term “(meth)acrylic acid” includes methacrylic acid and acrylic acid. Examples of useful comonomers for preparing the (meth)acrylic acid polymer component include vinyl monomers; vinylidene monomers; monoolefinic and polyolefinic monomers; and heterocyclic monomers. Preferred comonomers include substituted or unsubstituted ethylenically unsaturated carboxylic acids or derivatives thereof. The carboxylic acids may be mono- or poly-carboxylic acids. Useful carboxylic acid derivatives include esters, amides, nitriles, and anhydrides. Various combinations of comonomers may be used if desired.

Particularly preferred comonomers include, for example, alkyl acrylates (preferably having 1-4 carbon atoms (e.g., butyl acrylate)), a sulfated castor oil, sodium sulfostyrene, itaconic acid, a vinylidene monomer, a polyolefinic monomer, a heterocyclic monomer, a poly-carboxylic acid, a carboxylic acid ester, a carboxylic acid amide, a carboxylic acid nitrile, a carboxylic acid anhydride, or a mixture thereof. U.S. Pat. No. 4,937,123 (Chang et al.), U.S. Pat. No. 5,744,201 (Chang et al.), and U.S. Pat. No. 5,955,413 (Campagna et al.) describe (meth)acrylic acid-based comonomers useful in compositions of the present disclosure, along with procedures for preparing (meth)acrylic acid homopolymers and copolymers. Suitable (meth)acrylic acid-containing polymers are also commercially available under the tradenames LEUKOTAN 970 and LEUKOTAN 1028 from Dow Chemical Co., Midland, Mich.

Particularly preferred comonomers include, for example, alkyl acrylates (preferably having 1-4 carbon atoms (e.g., butyl acrylate)), itaconic acid, sodium sulfostyrene, and sulfated castor oil. A preferred (meth)acrylic acid polymer component includes a copolymer of methacrylic acid and butyl acrylate, and sulfated castor oil.

In certain embodiments, the (meth)acrylic acid polymer component does not include an emulsifying ability, i.e., it is non-emulsifying, as determined by the Emulsification Test for Polymer Material (as described in the Examples Section). A material that is non-emulsifying, as defined herein, demonstrates separation of the phases in less than 1 minute according to this test. This is typically because there is no significant lipophilic portion in the material.

In certain embodiments, the (meth)acrylic acid polymer of the (meth)acrylic acid polymer component does not include any crosslinking. In certain embodiments, the (meth)acrylic acid polymer of the (meth)acrylic acid polymer component has a weight average molecular weight of less than 1 million. Higher molecular weights than this can cause the composition to be too viscous. In certain embodiments, the (meth)acrylic acid polymer has a weight average molecular weight of less than 250,000 Daltons (Da).

A polymer that is typically not useful in compositions of the present disclosure is a crosslinked acrylic acid polymer, such as that available under the tradename CARBOPOL (ultra-high molecular weight polyacrylic acid polymers consisting of 500,000 molecular weight segments crosslinked into an ultrahigh molecular weight network, e.g., in the billions), or the tradename PEMULEN (crosslinked copolymers of acrylic and (C10-C30)alkyl acrylates, having a molecular weight in the billions), both of which are commercially available from Lubrizol, Cleveland, Ohio PEMULEN polymers, which are disclosed as desirable in the carpet-cleaning compositions of U.S. Pat. No. 6,326,344 (Levitt), are typically used to form stable oil-in-water emulsions because they contain both hydrophobic and hydrophilic portions within the molecule. This allows for lower levels of surfactant in the carpet-cleaning compositions of U.S. Pat. No. 6,326,344 (Levitt).

The (meth)acrylic acid polymer component may be present in the composition in an amount which, upon cleaning a substrate with the composition, provides at least partial stain-blocking properties. If too little of the (meth)acrylic acid polymer is present, stain-blocking properties may be diminished; if too much polymer is present, the substrate can have a stiff and unpleasant feel and/or the cleaning ability of the composition is worse than if no (meth)acrylic acid polymer is used.

The (meth)acrylic acid polymer solids typically makes up at least 0.5 weight percent (wt-%), or at least 1 wt-%, based on the total weight of the composition. The (meth)acrylic acid polymer component typically is present in the compositions of the present disclosure in an amount of up to 5 wt-%, or up to 4 wt-%, of polymer solids, based on the total weight of the composition.

### Water and Optional Organic Solvents

In certain embodiments, water is present in compositions of the present disclosure in an amount of at least 50 wt-% water, or at least 60 wt-%, or at least 70 wt-%, or at least 80 wt-%, based on the total weight of the composition. In certain embodiments, water is present in compositions of the present disclosure in an amount of up to 95 wt-%, or up to 90 wt-%, based on the total weight of the composition.

Although it is possible that the compositions of the present disclosure contain no organic solvent, it may be necessary that a small amount of a compatible organic solvent be included in a composition. Such organic solvent may be used, e.g., because it has been included as part of the commercially available ingredients used (e.g., as a solvent or remnant of production), in order to dissolve one or more other ingredients within the composition, or to assist in dissolving oily stains. Examples of suitable organic solvents include those soluble in water, such as alcohols, ethers, glycol ethers, ketones, etc. A preferred organic solvent is a glycol ether (e.g., 1-methoxy-2-propanol). Generally, an organic solvent may be used in an amount of at least 0.5 wt-%, or at least 1 wt-%, based on the total weight of the composition. Generally, an organic solvent may be used in an amount of up to 3 wt-%, or up to 1 wt-%, based on the total weight of the composition.

### Optional Additives

Various optional additives may be included in the compositions of the present disclosure. For example, in compositions of the present disclosure, enzyme stabilizers may be used. Preferred enzyme stabilizers include boron compounds, calcium salts, or combinations thereof. More preferred, the enzyme stabilizer is a boron compound selected from the group consisting of boronic acid, boric acid, borate, polyborate, and combinations thereof. An exemplary boron compound is B(OH)₃ (boric acid) available from EMD Chemicals, Inc., Gibbstown, N.J.). If used, a boron compound is typically present in an amount of at least 0.2 wt-%, and typically no more than 10 wt-%, based on the total weight of the composition. If used, a calcium salt is typically present in an amount of at least 0.01 wt-%, and typically no more than 3 wt-%, based on the total weight of the composition.

In addition to the (meth)acrylic acid polymer, other chemicals considered in the carpet cleaning art to be stain-blocking agents may be included in the composition (referred to herein as a “secondary stain-blocking agent”). Such secondary stain-blocking agents may be, for example, a partially sulfonated aromatic condensation polymer such as 3M Stain Release Concentrate available under the tradename FC-369, available from 3M Company, St. Paul, Minn. A secondary stainblocking agent, if used, can generally be present in an amount in the range from 0 to 10 wt-%, preferably 1 to 5 wt-%, of a concentrate composition, and from 0 to 0.156 wt-%, preferably 0.016 to 0.078 wt-%, of an aqueous use dilution. Within these ranges, it is preferred that the ratio of methacrylic acid polymer component to secondary stainblocking agent be in the range from 1:0 to 1:1, and preferably 6:1.

Compositions of the present disclosure may optionally contain other ingredients, such as odor absorbers (e.g., chelate-free zinc salt dispersions, such as that available from Innovative Chemical Technologies, Cartersville, Ga., under the trade designation “FLEXISORB OD-120-ZnR”), builders, fragrances, preservatives, embrittling agents (e.g., compounds that help keep residue brittle so it may be readily vacuumed when dry), sequestering agents, fluorochemicals, pH adjusters (e.g., acids such as HCl and bases such as ammonium hydroxide), hydrotropes, and the like. If used, these added ingredients may be used in an amount of at least 0.05 wt-%, and up to 5 wt-%, based on the total weight of the composition.

### Methods of Making and Using

Compositions of the present disclosure may be prepared by combining the ingredients, heated or unheated, with stirring until a uniform mixture is obtained.

In use, a composition of the present disclosure may be applied to a textile, particularly a carpet, using cleaning methods known in the industry (e.g., carpet cleaning industry). Generally, a method of cleaning and protecting a soiled textile involves: applying (e.g., by spraying) a composition as described herein to the soiled textile; and optionally, after a period of time (typically less than 10 minutes or less than 5 minutes), removing the composition from the textile.

If desired, the composition may not need to be removed from the composition. If it is removed, however, removing the composition from the textile will typically remove at least a portion of the soil (e.g., materials typically found in bodily fluids, such as blood, urine, vomit, feces, etc.), and provide protection as described herein. Removing can involve blotting dry, applying steam or liquid water to rinse the area, vacuuming the composition after it has dried, etc.

A preferred method involves spot cleaning and blotting. For example, in cleaning pet insults, any solid residue is removed, the composition applied to the soiled area, and optionally after a period of time (e.g., a few minutes) the soiled area is blotted dry.

An alternative method includes the step of hot water extraction, wherein the aqueous composition of the present disclosure is delivered to a textile, particularly a carpet, via a conventional delivery device, such as a high pressure pump. The spent composition is subsequently removed, e.g., by a wet vacuum system. Cleaning of the textile is performed during this flushing and rinsing process.

When a composition is used to clean a soiled textile, the cleaned textile is imparted with anti-resoiling properties provided by the composition of the present disclosure.

Significantly, using compositions of the present disclosure, subsequent steps of treating the cleaned textile with a fluorochemical repellent to provide soil resistance may be avoided.

### EXEMPLARY EMBODIMENTS

Embodiment 1 is an aqueous enzyme cleaning and protecting composition comprising: water; a protease; a surfactant selected from an anionic surfactant, a nonionic surfactant, an amphoteric surfactant, and a combination thereof; and a (meth)acrylic acid polymer component that is non-emulsifying; wherein the composition demonstrates protease activity.

Embodiment 2 is the composition of embodiment 1 which demonstrates protease activity of at least 15% of a control.

Embodiment 3 is the composition of embodiment 2 which demonstrates protease activity of at least 20% of a control.

Embodiment 4 is the composition of embodiment 3 which demonstrates protease activity of at least 30% of a control.

Embodiment 5 is the composition of any of embodiments 1 through 4 comprising at least two different enzymes of different classes.

Embodiment 6 is the composition of embodiment 5 further comprising an amylase, wherein the composition demonstrates amylase activity.

Embodiment 7 is the composition of embodiment 6 which demonstrates amylase activity of at least 15% of a control.

Embodiment 8 is the composition of embodiment 7 which demonstrates amylase activity of at least 20% of a control.

Embodiment 9 is the composition of embodiment 8 which demonstrates amylase activity of at least 30% of a control.

Embodiment 10 is the composition of any of embodiments 5 through 9 further comprising a lipase, wherein the composition demonstrates lipase activity.

Embodiment 11 is the composition of embodiment 10 which demonstrates lipase activity of at least 10% of a control.

Embodiment 12 is the composition of embodiment 11 which demonstrates lipase activity of at least 15% of a control.

Embodiment 13 is the composition of embodiment 12 which demonstrates lipase activity of at least 20% of a control.

Embodiment 14 is the composition of any of embodiments 1 through 13 wherein the surfactant is present in an amount of at least 0.1 wt-% of surfactant solids, based on the total weight of the composition.

Embodiment 15 is the composition of any of embodiments 1 through 14 wherein the surfactant is present in an amount of up to 5 wt-% of surfactant solids, based on the total weight of the composition.

Embodiment 16 is the composition of any of embodiments 1 through 15 wherein the surfactant is an anionic surfactant.

Embodiment 17 is the composition of embodiment 16 wherein the anionic surfactant is selected from a sulfonate, a sulfate, a sulfosuccinate, and a combination thereof.

Embodiment 18 is the composition of any of embodiments 1 through 17 wherein the surfactant is a nonionic surfactant.

Embodiment 19 is the composition of embodiment 18 wherein the nonionic surfactant is selected from an alcohol ethoxylate, an alkyl polyglucoside, and a combination thereof.

Embodiment 20 is the composition of any of embodiments 1 through 19 wherein the surfactant is an amphoteric surfactant.

Embodiment 21 is the composition of embodiment 20 wherein the amphoteric surfactant is a betaine.

Embodiment 22 is the composition of any of embodiments 1 through 21 comprising a mixture of surfactants.

Embodiment 23 is the composition of any of embodiments 1 through 22 wherein the (meth)acrylic acid polymer component is present in an amount of at least 0.5 wt-% of polymer solids, based on the total weight of the composition.

Embodiment 24 is the composition of any of embodiments 1 through 23 wherein the (meth)acrylic acid polymer component is present in an amount of up to 5 wt-% of polymer solids, based on the total weight of the composition.

Embodiment 25 is the composition of any of embodiments 1 through 24 wherein the (meth)acrylic acid polymer component comprises a polymer having a weight average molecular weight of less than 1 million Da.

Embodiment 26 is the composition of any of embodiments 1 through 25 wherein the (meth)acrylic acid polymer component comprises a polymer having monomeric units derived from a (meth)acrylic acid monomer and one or more ethylenically unsaturated comonomers.

Embodiment 27 is the composition of embodiment 26 wherein the comonomers comprise an alkyl acrylate, a sulfated castor oil, sodium sulfostyrene, itaconic acid, a vinylidene monomer, a polyolefinic monomer, a heterocyclic monomer, a poly-carboxylic acid, a carboxylic acid ester, a carboxylic acid amide, a carboxylic acid nitrile, a carboxylic acid anhydride, or a mixture thereof.

Embodiment 28 is the composition of embodiment 27 wherein the (meth)acrylic acid polymer component is derived from methacrylic acid, butyl acrylate, and a sulfated castor oil.

Embodiment 29 is the composition of any of embodiments 1 through 28 comprising at least 50 wt-% water, based on the total weight of the composition.

Embodiment 30 is the composition of any of embodiments 1 through 29 further comprising an organic solvent.

Embodiment 31 is the composition of any of embodiments 1 through 30 further comprising an enzyme stabilizer.

Embodiment 32 is the composition of embodiment 31 wherein the enzyme stabilizer comprises a boron compounds, a calcium salt, or a combination thereof.

Embodiment 33 is an aqueous enzyme cleaning and protecting composition comprising: water; one or more enzymes comprising a protease and an amylase; one or more surfactants selected from an anionic surfactant, a nonionic surfactant, an amphoteric surfactant, and a combination thereof; and a non-emulsifying (meth)acrylic acid polymer component polymer component comprising a polymer having monomeric units derived from a (meth)acrylic acid monomer and one or more ethylenically unsaturated comonomers; wherein the composition demonstrates protease activity; and wherein the composition demonstrates amylase activity.

Embodiment 34 is an aqueous enzyme cleaning and protecting composition comprising: water; a protease; a surfactant selected from an anionic surfactant, a nonionic surfactant, an amphoteric surfactant, and a combination thereof; and a (meth)acrylic acid polymer component comprises a polymer having a weight average molecular weight of less than 1 million Da; wherein the composition demonstrates protease activity.

Embodiment 35 is the composition of embodiment 34 which demonstrates protease activity of at least 15% of a control.

Embodiment 36 is the composition of embodiment 35 which demonstrates protease activity of at least 20% of a control.

Embodiment 37 is the composition of embodiment 36 which demonstrates protease activity of at least 30% of a control.

Embodiment 38 is the composition of any of embodiments 34 through 37 comprising at least two different enzymes of different classes.

Embodiment 39 is the composition of embodiment 38 further comprising an amylase, wherein the composition demonstrates amylase activity.

Embodiment 40 is the composition of embodiment 39 which demonstrates amylase activity of at least 15% of a control.

Embodiment 41 is the composition of embodiment 40 which demonstrates amylase activity of at least 20% of a control.

Embodiment 42 is the composition of embodiment 41 which demonstrates amylase activity of at least 30% of a control.

Embodiment 43 is the composition of any of embodiments 38 through 42 further comprising a lipase, wherein the composition demonstrates lipase activity.

Embodiment 44 is the composition of embodiment 43 which demonstrates lipase activity of at least 10% of a control.

Embodiment 45 is the composition of embodiment 44 which demonstrates lipase activity of at least 15% of a control.

Embodiment 46 is the composition of embodiment 45 which demonstrates lipase activity of at least 20% of a control.

Embodiment 47 is the composition of any of embodiments 34 through 46 wherein the surfactant is present in an amount of at least 0.1 wt-% of surfactant solids, based on the total weight of the composition.

Embodiment 48 is the composition of any of embodiments 34 through 47 wherein the surfactant is present in an amount of up to 5 wt-% of surfactant solids, based on the total weight of the composition.

Embodiment 49 is the composition of any of embodiments 34 through 48 wherein the surfactant is an anionic surfactant.

Embodiment 50 is the composition of embodiment 49 wherein the anionic surfactant is selected from a sulfonate, a sulfate, a sulfosuccinate, and a combination thereof.

Embodiment 51 is the composition of any of embodiments 34 through 50 wherein the surfactant is a nonionic surfactant.

Embodiment 52 is the composition of embodiment 51 wherein the nonionic surfactant is selected from an alcohol ethoxylate, an alkyl polyglucoside, and a combination thereof.

Embodiment 53 is the composition of any of embodiments 34 through 52 wherein the surfactant is an amphoteric surfactant.

Embodiment 54 is the composition of embodiment 53 wherein the amphoteric surfactant is a betaine.

Embodiment 55 is the composition of any of embodiments 34 through 54 comprising a mixture of surfactants.

Embodiment 56 is the composition of any of embodiments 34 through 55 wherein the (meth)acrylic acid polymer component is present in an amount of at least 0.5 wt-% of polymer solids, based on the total weight of the composition.

Embodiment 57 is the composition of any of embodiments 34 through 56 wherein the (meth)acrylic acid polymer component is present in an amount of up to 5 wt-% of polymer solids, based on the total weight of the composition.

Embodiment 58 is the composition of any of embodiments 34 through 57 wherein the (meth)acrylic acid polymer component comprises a polymer having monomeric units derived from a (meth)acrylic acid monomer and one or more ethylenically unsaturated comonomers.

Embodiment 59 is the composition of embodiment 58 wherein the comonomers comprise an alkyl acrylate, a sulfated castor oil, sodium sulfostyrene, itaconic acid, a vinylidene monomer, a polyolefinic monomer, a heterocyclic monomer, a poly-carboxylic acid, a carboxylic acid ester, a carboxylic acid amide, a carboxylic acid nitrile, a carboxylic acid anhydride, or a mixture thereof.

Embodiment 60 is the composition of embodiment 59 wherein the (meth)acrylic acid polymer component is derived from methacrylic acid, butyl acrylate, and a sulfated castor oil.

Embodiment 61 is the composition of any of embodiments 34 through 60 comprising at least 50 wt-% water, based on the total weight of the composition.

Embodiment 62 is the composition of any of embodiments 34 through 61 further comprising an organic solvent.

Embodiment 63 is the composition of any of embodiments 34 through 62 further comprising an enzyme stabilizer.

Embodiment 64 is the composition of embodiment 63 wherein the enzyme stabilizer comprises a boron compounds, a calcium salt, or a combination thereof.

Embodiment 65 is an aqueous enzyme cleaning and protecting composition comprising: water; one or more enzymes comprising a protease and an amylase; one or more surfactants selected from an anionic surfactant, a nonionic surfactant, an amphoteric surfactant, and a combination thereof; and a (meth)acrylic acid polymer component comprises a polymer having a weight average molecular weight of less than 1 million Da and having monomeric units derived from a (meth)acrylic acid monomer and one or more ethylenically unsaturated comonomers; wherein the composition demonstrates protease activity; and wherein the composition demonstrates amylase activity.

Embodiment 66 is a method of cleaning and protecting a soiled textile, the method comprising: applying a composition of any of embodiments 1 through 65 to the soiled textile; and optionally, after a period of time, removing the composition from the textile.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Test Methods

### Enzyme Activity Test for Samples of the Present Disclosure

Activities of select protease, amylase, and lipase enzymes in a given test cleaning formulation were measured according to the following assay descriptions. For each test cleaning formulation, enzyme activity in the test cleaning formulation was measured according to each of the enzyme assays described below, and the enzyme activity of a corresponding enzyme solution was also measured. “Corresponding enzyme solution” refers to a solution that contains the same enzyme(s) at the same concentration(s) as present in the test cleaning formulation, with no other components other than water present in the corresponding test cleaning formulation.

A relative enzyme activity for each of the enzyme assays described below was calculated using the general Equation I:

$$Relative enzyme activity ( percentage ) = 100 \frac{{A}_{net} of a test cleaning formulation}{{A}_{net} of a corresponding enzyme solution} \qquad ( Eqn . I )$$

where the term Aₙₑₜ was an absorbance value representing enzyme activity, as described in each of the enzyme assays below.

Protease Activity Assay: Protease activity was measured based on a colorimetric method using azocasein substrate. A 0.625% (w/v) azocasein (Sigma-Aldrich) solution in 0.5% (w/v) in sodium bicarbonate buffer, pH 8.3, was warmed up in 37° C. water bath. Then, 0.8 milliliter (mL) of azocasein solution and a 0.2 mL aliquot of the unknown cleaning formula were transferred to a 5 mL centrifuge tube, mixed by swirling and were incubated at 37° C. in a water bath for 30 min. After that, 4 mL of 0.305 N trichloroacetic acid solution was added and mixed by swirling, then was filtered using 0.45 micrometer (μm) polypropylene membrane syringe filters into new 5 mL microfuge tubes. A 0.05 mL aliquot was transferred to a well plate and mixed with 0.15 mL of 500 millimolar (mM) NaOH. An absorbance reading at 440 nm (A₁) was then measured. The A₁ absorbance reading represented an absorbance of a sample that had an opportunity for protease enzyme to cleave the azocasein substrate.

In order to provide a suitable background sample that accounts for absorbance due to sample components other than cleavage products of azocasein (e.g., colorants in the test cleaning formulation), the following “background” sample was prepared as follows. A 0.625% (w/v) azocasein solution in 0.5% (w/v) in sodium bicarbonate buffer, pH 8.3, was warmed up in 37° C. water bath. Then, 0.8 milliliter (mL) of the azocasein solution was transferred to a 5 mL centrifuge tube, mixed by swirling and was incubated at 37° C. in a water bath for 30 min. After that, 4 mL of 0.305 N trichloroacetic acid solution was added and mixed by swirling, then a 0.2 mL aliquot of the test cleaning formulation was added and mixed briefly, and then was filtered using 0.45 micron (μm) polypropylene membrane syringe filters into new 5 mL microfuge tubes. A 0.05 mL aliquot was transferred to a well plate and mixed with 0.15 mL of 500 millimolar (mM) NaOH. An absorbance reading at 440 nm (A₀) was then measured. The A₀ absorbance reading represented a background absorbance of a sample that had not had an opportunity for protease enzyme to cleave the azocasein substrate.

A net absorbance value of the test cleaning formulation (i.e., “Aₙₑₜ of test cleaning formulation”) was calculated, by subtracting A₀ from A₁. The calculated Aₙₑₜ absorbance value represented a level of protease activity of the test cleaning formulation. Thus, for the Protease Activity Assay:

Aₙₑₜ=A₁−A₀

In addition, a net absorbance value of a corresponding enzyme solution (i.e., “Aₙₑₜ of corresponding enzyme solution”) was measured, after subjecting the corresponding enzyme solution to the same test protocol as above, in place of the test cleaning formulation. As described above, a “corresponding enzyme solution” contained the same enzyme(s) at the same concentration(s) as present in the test cleaning formulation, with no other components other than water present in the corresponding test cleaning formulation.

Amylase Activity Assay: Amylase activity was measured based on a colorimetric method using starch azure substrate. A 1.0% (w/v) starch azure (Sigma-Aldrich) suspension in 1.125 mL of 20 mM sodium phosphate buffer with 50 mM sodium chloride, pH 7, and a 0.125 mL aliquot of test cleaning formulation were transferred to a microfuge tube, mixed by shaking and incubated for 30 minutes at room temperature on a rocker. Then, 0.5 mL 2.75 molar (M) acetic acid was added and mixed by swirling, followed by centrifugation for 5 minutes at 10,000 revolutions per minute (rpm). A 0.2 mL aliquot of the resulting supernatant was transferred to a well plate. An absorbance reading at 595 nm (A₁) was then measured. The A₁ absorbance reading represented an absorbance of a sample that had an opportunity for amylase enzyme to cleave the starch azure substrate.

In order to provide a suitable background sample that accounted for absorbance due to sample components other than cleavage products of starch azure (e.g., colorants in the test cleaning formulation), the following “background” sample was prepared as follows. A 1.0% (w/v) starch azure suspension in 1.125 mL of 20 mM sodium phosphate buffer with 50 mM sodium chloride, pH 7, was transferred to a microfuge tube, mixed by shaking and incubated for 30 minutes at room temperature on a rocker. Then, 0.5 mL 2.75 molar (M) acetic acid was added and mixed by swirling, then 0.125 mL aliquot of test cleaning formulation was added, followed by centrifugation for 5 minutes at 10,000 revolutions per minute (rpm). A 0.2 mL aliquot of the resulting supernatant was transferred to a well plate. An absorbance reading at 595 nm (A₀) was then measured. The A₀ absorbance reading represented a background absorbance of a sample that had not had an opportunity for amylase enzyme to cleave the starch azure substrate.

A net absorbance value of the test cleaning formulation (i.e., “Aₙₑₜ of test cleaning formulation”) was calculated, by subtracting A₀ from A₁. The calculated Aₙₑₜ absorbance value represented a level of amylase activity of the test cleaning formulation. Thus, for the Amylase Activity Assay:

Aₙₑₜ=A₁−A₀

In addition, a net absorbance value of a corresponding enzyme solution (i.e., “Aₙₑₜ of corresponding enzyme solution”) was measured, after subjecting the corresponding enzyme solution to the same test protocol as above, in place of the test cleaning formulation. As described above, a “corresponding enzyme solution” contained the same enzyme(s) at the same concentration(s) as present in the test cleaning formulation, with no other components other than water present in the corresponding test cleaning formulation.

Lipase Activity Assay: Lipase activity was measured based on a spectrophotometric method using a vinyl stearate substrate, using a modification of the method described in L. Goujard et al., Anal. Biochem., 385, 161-167 (2009). Five mL of 20 mM pentanol and 20 mM of vinyl stearate from TCI America (Portland, Oreg.) in hexane was added to a glass vial. A 0.5 mL aliquot of test cleaning formulation was added and mixed by swirling. Immediately, a 0.01 mL portion of the mixture was transferred to a glass vial containing 1.99 mL of dried acetonitrile, and vortexed. The absorbance reading at 200 nm (A₀) was then measured. The A₀ absorbance reading represented an initial absorbance of a sample that had not had an opportunity for lipase enzyme to catalyze the transesterification between vinyl stearate and pentanol. The remaining mixed sample was then incubated for 30 minutes at room temperature on a rocker. After incubation, a 0.01 mL portion of the mixture was transferred to a glass vial containing 1.99 mL of dried acetonitrile, and vortexed. The absorbance reading at 200 nm (A₁) was then measured. The A₁ absorbance reading represented a final absorbance of a sample that had had an opportunity for lipase enzyme to catalyze the transesterification between vinyl stearate and pentanol.

A net absorbance value of the test cleaning formulation (i.e., “Aₙₑₜ of test cleaning formula”) was calculated, by subtracting A₁ from A₀. The calculated Aₙₑₜ absorbance value represented a level of lipase activity of the test cleaning formulation. Thus, for the Lipase Activity Assay:

Aₙₑₜ=A₀−A₁

In addition, a net absorbance value of a corresponding enzyme solution (i.e., “Aₙₑₜ of corresponding enzyme solution”) was measured, after subjecting the corresponding enzyme solution to the same test protocol as above, in place of the test cleaning formula. As described above, a “corresponding enzyme solution” contained the same enzyme(s) at the same concentration(s) as present in the test cleaning formulation, with no other components other than water present in the corresponding test cleaning formulation.

### Enzyme Activity Test for an Unknown Cleaning Formulation

Activities of protease, amylase, and lipase enzymes in a given unknown cleaning formulation can be measured according to the following enzyme assay descriptions, to obtain at least a qualitative indication of enzyme activity. Additionally, enzyme activity of a “reference enzyme solution” can be measured, for calculation of a relative enzyme activity of the unknown cleaning solution against the reference enzyme solution. “Reference enzyme solution” here refers to a solution that contains 0.5 weight percent of each of the enzyme product solutions of Protease 1, Amylase 1, and Lipase 1, which are listed in Table 1, in distilled water. Alternatively, other enzyme product solutions at the equivalent enzyme activity level can be used.

A relative enzyme activity for each of the enzyme assays for an unknown cleaning formulation described below was calculated using the general Equation II:

$$Relative enzyme activity ( percentage ) = 100 \frac{{A}_{net} of an unknown cleaning formulation}{{A}_{net} of a reference enzyme solution} \qquad ( Eqn . II )$$

where the term Aₙₑₜ was an absorbance value representing enzyme activity, as described in each of the enzyme assays below.

Determination of Protease Activity for an Unknown Cleaning Formulation: Protease activity of an unknown cleaning formula can be measured based on a colorimetric method using azocasein substrate. A 0.625% (w/v) azocasein (Sigma-Aldrich) solution in 0.5% (w/v) in sodium bicarbonate buffer, pH 8.3, is warmed up in 37° C. water bath. Then, 0.8 milliliter (mL) of azocasein solution and a 0.2 mL aliquot of the unknown cleaning formula are transferred to a 5 mL centrifuge tube, mixed by swirling and are incubated at 37° C. in a water bath for 30 min. After that, 4 mL of 0.305 N trichloroacetic acid solution is added and mixed by swirling, then is filtered using 0.45 micrometer (μm) polypropylene membrane syringe filters into new 5 mL microfuge tubes. A 0.05 mL aliquot is transferred to a well plate and mixed with 0.15 mL of 500 millimolar (mM) NaOH. An absorbance reading at 440 nm (A₁) is then measured. The A₁ absorbance reading represents an absorbance of a sample that has had an opportunity for protease enzyme to cleave the azocasein substrate.

In order to provide a suitable background sample that accounts for absorbance due to sample components other than cleavage products of azocasein (e.g., colorants in the unknown cleaning formulation), the following “background” sample is prepared as follows. A 0.625% (w/v) azocasein (Sigma-Aldrich) solution in 0.5% (w/v) in sodium bicarbonate buffer, pH 8.3, is warmed up in 37° C. water bath. Then, 0.8 milliliter (mL) of the azocasein solution is transferred to a 5 mL centrifuge tube, mixed by swirling and is incubated at 37° C. in a water bath for 30 min. After that, 4 mL of 0.305 N trichloroacetic acid solution is added and mixed by swirling, then a 0.2 mL aliquot of the unknown cleaning formula is added and mixed briefly, and then is filtered using 0.45 micron (μm) polypropylene membrane syringe filters into new 5 mL microfuge tubes. A 0.05 mL aliquot is transferred to a well plate and mixed with 0.15 mL of 500 millimolar (mM) NaOH. An absorbance reading at 440 nm (A₀) is then measured. The A₀ absorbance reading represents a background absorbance of a sample that has not had an opportunity for protease enzyme to cleave the azocasein substrate.

A net absorbance value (Aₙₑₜ) is calculated, by subtracting A₀ from A₁: The calculated Aₙₑₜ absorbance value represents a level of protease activity of the unknown cleaning formulation:

Aₙₑₜ=A₁−A₀

In addition, a net absorbance value of a reference enzyme solution (i.e., “Aₙₑₜ of a reference enzyme solution”) is measured, after subjecting the reference enzyme solution to the same test protocol as above, in place of the unknown cleaning formulation. As described above, a “reference enzyme solution” contains 0.5 weight percent of each of the enzyme product solutions of Protease 1, Amylase 1 and Lipase 1, which are listed in Table 1, or equivalent enzyme product solutions, in distilled water.

Determination of Amylase Activity for an Unknown Cleaning Formulation: Amylase activity can be measured based on a colorimetric method using starch azure substrate. A 1.0% (w/v) starch azure suspension in 1.125 mL of 20 mM sodium phosphate buffer with 50 mM sodium chloride, pH 7, and a 0.125 mL aliquot of unknown cleaning formulation are transferred to a microfuge tube, mixed by shaking and incubated for 30 minutes at room temperature on a rocker. Then, 0.5 mL 2.75 molar (M) acetic acid is added and mixed by swirling, followed by centrifugation for 5 minutes at 10,000 revolutions per minute (rpm). A 0.2 mL aliquot of the resulting supernatant is transferred to a well plate. An absorbance reading at 595 nm (A₁) is then measured. The A₁ absorbance reading represented an absorbance of a sample that had an opportunity for amylase enzyme to cleave the starch azure substrate.

In order to provide a suitable background sample that accounted for absorbance due to sample components other than cleavage products of starch azure (e.g., colorants in the test cleaning formulation), the following “background” sample was prepared as follows. A 1.0% (w/v) starch azure suspension in 1.125 mL of 20 mM sodium phosphate buffer with 50 mM sodium chloride, pH 7, was transferred to a microfuge tube, mixed by shaking and incubated for 30 minutes at room temperature on a rocker. Then, 0.5 mL 2.75 molar (M) acetic acid was added and mixed by swirling, then 0.125 mL aliquot of unknown cleaning formulation was added, followed by centrifugation for 5 minutes at 10,000 revolutions per minute (rpm). A 0.2 mL aliquot of the resulting supernatant was transferred to a well plate. An absorbance reading at 595 nm (A₀) was then measured. The A₀ absorbance reading represented a background absorbance of a sample that has not had an opportunity for amylase enzyme to cleave the starch azure substrate.

A net absorbance value of the test cleaning formulation (i.e., “Aₙₑₜ of test cleaning formulation”) is calculated, by subtracting A₀ from A₁. The calculated Aₙₑₜ absorbance value represents a level of amylase activity of the test cleaning formulation:

Aₙₑₜ=A₁−A₀

In addition, a net absorbance value of a reference enzyme solution (i.e., “Aₙₑₜ of a reference enzyme solution”) is measured, after subjecting the reference enzyme solution to the same test protocol as above, in place of the unknown cleaning formulation. As described above, a “reference enzyme solution” contains 0.5 weight percent of each of the enzyme product solutions of Protease 1, Amylase 1, and Lipase 1, which are listed in Table 1, or equivalent enzyme product solutions, in distilled water.

Determination of Lipase Activity for an Unknown Cleaning Formulation: Lipase activity can be measured based on a spectrophotometric method using a vinyl stearate substrate, using a modification of the method described in L. Goujard et al., Anal. Biochem., 385, 161-167 (2009). Five mL of 20 mM pentanol and 20 mM of vinyl stearate from TCI America (Portland, Oreg.) in hexane is added to a glass vial. A 0.5 mL aliquot of test cleaning formulation is added and mixed by swirling. Immediately, a 0.01 mL portion of the mixture is transferred to a glass vial containing 1.99 mL of dried acetonitrile, and vortexed. The absorbance reading at 200 nm (A₀) is then measured. The A₀ absorbance reading represents an initial absorbance of a sample that has not had an opportunity for lipase enzyme to catalyze the transesterification between vinyl stearate and pentanol. The remaining mixed sample is then incubated for 30 minutes at room temperature on a rocker. After incubation, a 0.01 mL portion of the mixture is transferred to a glass vial containing 1.99 mL of dried acetonitrile, and vortexed. The absorbance reading at 200 nm (A₁) is then measured. The A₁ absorbance reading represents a final absorbance of a sample that has had an opportunity for lipase enzyme to catalyze the transesterification between vinyl stearate and pentanol.

A net absorbance value of the test cleaning formulation (i.e., “Aₙₑₜ of test cleaning formula”) is calculated, by subtracting A₁ from A₀. The calculated Aₙₑₜ absorbance value represents a level of lipase activity of the test cleaning formulation. Thus, for the Lipase Activity Assay:

Aₙₑₜ=A₀−A₁

In addition, a net absorbance value of a reference enzyme solution (i.e., “Aₙₑₜ of a reference enzyme solution”) is measured, after subjecting the reference enzyme solution to the same test protocol as above, in place of the unknown cleaning formulation. As described above, a “reference enzyme solution” contains 0.5 weight percent of each of the enzyme product solutions of Protease 1, Amylase 1, and Lipase 1, which are listed in Table 1, or equivalent enzyme product solutions, in distilled water.

### Textile Cleaning Test

A textile cleaning test, adapted from “Carpet and Rug Institute CRI Test Method 116” (dated July, 2010), was conducted for each test cleaning formulation using the following test procedure. One can (156 grams (g)) of “MIGHTY DOG” dog food (Purina, St. Louis, Mo.) and 20 mL of water was mixed by a “WARING” blender. Concentrated HCl was slowly added until the mixture reached a pH of 3.3. A portion (2.5+/−0.1 g) of the food mixture was evenly distributed by a tongue depressor across the beige nylon 6 residential carpet (Mohawk Industries, Calhoun, Ga., “MOHAWK GENORA, STYLE PL-081”, color L015, factory fluorochemically-treated), then the food mixture was allowed to stain the carpet for 3 minutes. After removing the excess food mixture from the carpet, 15 g of a test cleaning sample was sprayed on the stained area. Three minutes after spraying, the stained area was scrubbed with a paper towel for 1.5 minutes with small circular strokes, and then scrubbed again for another 1.5 minutes with another paper towel. After drying the carpet at room temperature for 24 hours, the color difference (Delta E value) from virgin carpet was measured by a colorimeter (MINOLTA CR-200). The Delta E value was calculated according to Equation II (Eqn. II):

Delta E_{ab}*=[(L₂*−L₁*)²+[(a₂*−a₁*)²+[(b₂*−b₁*)²]^{1/2} (Eqn. II)

where L*, a* and b* are coordinates in three dimensional color space for samples.

### Resoiling Test

About 5 g (+/−0.3 g) of each test cleaning formulation was applied to beige nylon 6 residential carpet (obtained from Mohawk Industries, Calhoun, Ga., under the trade designation “MOHAWK GENORA, STYLE PL-081”, color L016, factory fluorochemically-treated) in 5.5 cm diameter circles to represent spot cleaning. The carpet was air-dried for several days, and then was subjected to foot traffic in a commercial setting for 12 days. The color difference (Delta E value) from virgin carpet was measured by a colorimeter (MINOLTA CR-200). The Delta E value was calculated according to Equation II (Eqn. II), presented above.

### Materials

Materials for the preparation of test samples included those materials listed in Table 1:

TABLE 1

| Name | Description and source |
|---|---|
| 1-Methoxy-2-propanol | 1-Methoxy-2-propanol, obtained from Alfa Aesar, Ward |
| | Hill, MA |
| Enzyme cleaner (“CE-1”) | An enzymatic cleaner, obtained from 3M Co., St. Paul, |
| | MN, under the trade designation “3M PRUVEN |
| | ENZYMATIC STAIN AND ODOR REMOVER” |
| AMPHOSOL CA | Cocamidopropyl betaine, an amphoteric surfactant |
| | (alkylamidopropyl betaine type), obtained from Stepan |
| | Company, Northfield, IL, under the trade designation |
| | “AMPHOSOL CA”, used at 35 wt-% solids in water |
| Amylase 1 | Alpha-Amylase from Bacillus Licheniformis Type XII- |
| | A, obtained from Sigma-Aldrich, St. Louis, MO, |
| | equivalent to TERMAMYL 120 (Novozymes), 1186 |
| | units/milligram (U/mg) protein |
| BIOSOFT D40 | Sodium dodecylbenzene sulfonate, an anionic surfactant |
| | (alkyl benzene sulfonate type), obtained from Stepan |
| | Company, Northfield, IL, under the trade designation |
| | “BIOSOFT D40”, used at 38 weight percent (wt-%) |
| | solids in water |
| BIOSOFT N23-6.5 | A C12-C13 linear alcohol with 6.5 moles of |
| | ethoxylation, a nonionic surfactant (alcohol ethoxylate |
| | type), obtained from Stepan Company, Northfield, IL, |
| | under the trade designation “BIOSOFT N23-6.5”, used |
| | at 100 wt-% solids |
| Boric acid | B(OH)₃, used as an enzyme stabilizer, obtained from |
| | EMD Chemicals, Inc., Gibbstown, NJ |
| FLEXISORB OD-120-ZnR | A chelate-free zinc salt dispersion, used herein as an |
| | odor absorber, obtained from Innovative Chemical |
| | Technologies, Cartersville, GA, under the trade |
| | designation “FLEXISORB OD-120-ZnR” |
| GLUCOPON 425N | A C8-C16 polyglucoside, a nonionic surfactant, |
| | obtained from BASF (Florham Park, New Jersey) under |
| | the trade designation “GLUCOPON 425N”, used at 50 wt- |
| | % solids in water |
| Lipase 1 | Lipase from Thermomyces lanuginosus (Sigma- |
| | Aldrich), equivalent to LIPOLASE 100L (Novozymes, |
| | Franklinton, NC), 100,000 units per gram (U/g) |
| PEMULEN 1622 | A high molecular weight, crosslinked copolymer of |
| | acrylic acid and C10-C30 alkyl acrylate obtained from |
| | Lubrizol Advanced Materials, Inc., Cleveland, OH, |
| | under the trade designation “PEMULEN 1622”, used at |
| | 100 wt-% solids |
| Protease 1 | Protease from Bacillus sp. obtained from Sigma- |
| | Aldrich, St. Louis, MO, equivalent to SAVINASE 16L |
| | (Novozymes, Franklinton, NC), 17 U/g |
| Stain Blocker 1 | A methacrylic acid copolymer-based stain blocker |
| | material, made as in Polymer I of U.S. Pat. No. |
| | 5,955,413 (Campagna et al.), and further neutralized |
| | with ammonium hydroxide to obtain an aqueous |
| | solution having 31% solids and a pH of 5.3 |
| STEOL CA-330 | Ammonium laureth sulfate, an anionic surfactant (alkyl |
| | ether sulfate type), obtained from Stepan Company, |
| | Northfield, IL, under the trade designation “STEOL CA- |
| | 330”, used at 28 wt-% solids in water |
| STEPANATE SXS | Sodium xylene sulfonate, an anionic surfactant |
| | (sulfonate type), obtained from Stepan Company, |
| | Northfield, IL, under the trade designation |
| | “STEPANATE SXS”, used at 43 wt-% solids in water |
| STEPANMILD SL3-BA | Disodium laureth sulfosuccinate, an anionic surfactant |
| | (sulfosuccinate type), obtained from Stepan Company, |
| | Northfield, IL, under the trade designation |
| | “STEPANMILD SL3-BA”, used at 30 wt-% solids in |
| | water |
| STEPANOL WA-EXTRA | Sodium lauryl sulfate, an anionic surfactant (alkyl |
| | sulfate type), obtained from Stepan Company, |
| | Northfield, IL, under the trade designation |
| | “STEPANOL WA-EXTRA”, used at 30 wt-% solids in |
| | water |

### Emulsification Test for Polymer Material

Water and a polymer to be tested for emulsion formation were mixed in ajar to make 50 grams of 0.6% by weight solids water phase at 22° C. A 0.87 gram portion of hexadecane (dyed red with Red O soluble dye, at a concentration of 0.2 gram of Red O per 1 U.S. gallon (3.79 liters) of hexadecane) was added to the rapidly stirred water phase, then the covered jar containing the mixed water and hexadecane phases was transferred to a horizontal shaker table set on high speed for 10 minutes. The shaker was stopped, the jar was placed in an upright position, and a separation time for the two phases to separate was noted.

### Emulsification Comparison Data for Stain Blocker 1 and PEMULEN 1622

Stain Blocker 1 and PEMULEN 1622 were tested separately in the “Emulsification Test for Polymer Material”. Separation times for the two materials are summarized in Table 2.

TABLE 2

| Sample | Separation Time |
|---|---|
| Stain Blocker 1 | <1 minute |
| PEMULEN 1622 | >1 week |

Stain Resistance Comparison Data for Formulations with Stain Blocker 1 or PEMULEN 1622

Formulations of Stain Blocker 1 (F-1) or PEMULEN 1622 (F-2) were prepared, both at 0.3% polymer solids, including the ingredients listed in Table 3:

TABLE 3

| | F-1 | F-2 |
|---|---|---|
| Ingredient | wt-% | wt-% |
| Water | 98.5 | 99.2 |
| BIOSOFT D40 | 0.5 | 0.5 |
| Stain Blocker 1 | 1.0 | 0 |
| PEMULEN 1622 | 0 | 0.3 |

Stain resistance of F-1 or F-2 samples was determined using the following test procedure. A 6-inch by 12-inch (15-cm by 30-cm) non-fluorochemically treated blue nylon 6,6 carpet sample (Beaulieu 2303 color “Blue Moon”) was stained for 24 hours at room temperature by 20 mL of an aqueous staining solution contained inside a 2.5-inch (6.4-cm) diameter circular dam. The aqueous staining solution consisted of 0.007 wt-% of Red Dye FD&C No. 40 in deionized water adjusted to a pH of 3.0 with 10% aqueous citric acid. Excess dye solution was then rinsed from the carpet sample by placing the dyed carpet sample under a stream of deionized water until the water ran clear. The rinsed carpet sample was then extracted to dampness using a Bock Centrifugal Extractor and was then air-dried overnight at room temperature. The degree of staining of the carpet sample was then determined numerically by using a Minolta CHROMA METER CR-310 compact tristimulus color analyzer.

The color analyzer measured red stain color autochromatically on the red-green color coordinate as a “delta a” (Δa) value as compared to the color of an unstained and untreated carpet sample. The Δa values were recorded to one place following the decimal point and represented the average of 3 measurements. A greater Δa reading indicated a greater amount of staining from the red dye. The residual stain from treatment with sample F-1 was slightly pink, having Δa value of 10.6 relative to an unstained, untreated carpet sample. The residual stain from treatment with F-2 was dark red, having a Δa value of 41.6 relative to an unstained, untreated carpet sample.

### Test Cleaning Formulas

Test cleaning formulations were prepared using the amounts summarized in Tables 4, 5, and 6, according to the surfactants used. Test cleaning formulations in Table 4 included anionic surfactants, test cleaning formulations in Table 5 included amphoteric surfactants, and test cleaning formulations in Table 6 included nonionic surfactants. Numerical values in Tables 4, 5, and 6 are weight percent values relative to total weight of the composition. Weight percent values of surfactant components are for the surfactant components listed in the Materials Table (Table 1), which were used as a mixture in water (as provided by the supplier). Weight percent values of protease, amylase, or lipase enzyme refer to the enzyme solutions as provided by the supplier. Each Example (“EX”) test cleaning formulation also included a stain blocker, wherein the weight percent values refer to the stain blocker solutions as provided by the supplier. The weight percents of water refer to added water (not including water provided with each component).

TABLE 4

| | EXAMPLE NUMBER | | | | | | | | | | | | |
|---|---|---|---|---|---|---|---|---|---|---|---|---|---|
| | | 2A, | | | | | | | | | | | |
| Ingredient | 1 | 2B | 3 | 4 | 5 | 6 | 7 | 8 | 9 | 10 | 11 | CE-2 | CE-3 |
| Water | 89.5 | 89 | 88.25 | 88 | 87.25 | 88.5 | 89.0 | 89.0 | 89.0 | 92.0 | 93.5 | 95.0 | 95.0 |
| STEPANATE | 3.0 | 3.0 | 3.0 | 3.0 | 3.0 | — | — | — | — | 3.0 | — | 3.0 | — |
| SXS | | | | | | | | | | | | | |
| STEPANOL | — | — | — | — | — | 3.0 | — | — | — | — | — | — | — |
| WA-EXTRA | | | | | | | | | | | | | |
| BIOSOFT D40 | — | — | — | — | — | — | 3.0 | — | — | — | — | — | — |
| STEPANMILD | — | — | — | — | — | — | — | 3.0 | — | — | 3.0 | — | 3.0 |
| SL3-BA) | | | | | | | | | | | | | |
| STEOL CA-330 | — | — | — | — | — | — | — | — | 3.0 | — | — | — | — |
| 1-Methoxy-2- | — | 1 | 1 | 1 | 1 | 1 | 1 | 1 | 1 | 1 | 1 | 1 | 1 |
| propanol | | | | | | | | | | | | | |
| Stain blocker 1 | 6 | 6 | 6 | 6 | 6 | 6 | 6 | 6 | 6 | 3 | 1.5 | — | — |
| Flexisorb OD- | — | — | 0.75 | — | 0.75 | — | — | — | — | — | — | — | — |
| 120-ZnR | | | | | | | | | | | | | |
| Boric acid | — | — | — | 1 | 1 | — | — | — | — | — | — | — | — |
| Protease 1 | 0.5 | 0.5 | 0.5 | 0.5 | 0.5 | 0.5 | 0.5 | 0.5 | 0.5 | 0.5 | 0.5 | 0.5 | 0.5 |
| Amylase 1 | 0.5 | 0.5 | 0.5 | 0.5 | 0.5 | 0.5 | 0.5 | 0.5 | 0.5 | 0.5 | 0.5 | 0.5 | 0.5 |
| Lipase 1 | 0.5 | — | — | — | — | 0.5 | — | — | — | — | — | — | — |
| Totals | 100 | 100 | 100 | 100 | 100 | 100 | 100 | 100 | 100 | 100 | 100 | 100 | 100 |

TABLE 5

Sample No.

| Ingredient | EX-12A, EX-12B | CE-4 |
|---|---|---|
| Water | 88 | 95.0 |
| AMPHOSOL CA | 3 | 3 |
| 1-Methoxy-2-propanol | 1 | 1 |
| Stain blocker 1 | 7 | — |
| Protease 1 | 0.5 | 0.5 |
| Amylase 1 | 0.5 | 0.5 |
| Totals | 100 | 100 |

TABLE 6

| | Sample No. | | |
|---|---|---|---|
| Ingredient | EX-13A, EX-13B | EX-14 | CE-5 |
| Water | 86 | 89.5 | 97.5 |
| GLUCOPON 425N (50% SOLIDS) | — | 3 | — |
| BIOSOFT N23-6.5 | 0.5 | — | 0.5 |
| 1-Methoxy-2-propanol | 1 | — | 1 |
| Stain blocker 1 | 11.5 | 6 | — |
| Protease 1 | 0.5 | 0.5 | 0.5 |
| Amylase 1 | 0.5 | 0.5 | 0.5 |
| Lipase 1 | — | 0.5 | — |
| Totals | 100 | 100 | 100 |

Several of the test cleaning formulations were evaluated individually for protease, amylase, and lipase activity, according to each respective Enzyme Activity Test, using separate samples to evaluate each of the enzyme activities for each of the test cleaning formulas. The calculated mean relative activity values were as summarized in Table 7 (“ND” refers to “Not Detectable”; “SD” refers to “Standard Deviation”, with n=3; where a measurement was not obtained, a dash is used). The percentage values in Table 7 are the mean percentages of the relative enzyme activity calculated according to Eqn. 1 and reported as a percentage of the corresponding enzyme solution used as a control.

TABLE 7

| | Protease 1 | | Amylase 1 | | Lipase 1 | |
|---|---|---|---|---|---|---|
| Formula | Mean | SD | Mean | SD | Mean | SD |
| CE-1 | ND | — | ND | — | ND | — |
| EX-1 | 64.1% | 6.5% | 86.1% | 0.8% | 13.5% | 1.2% |
| EX-2A | 62.4% | 3.5% | 80.3% | 6.7% | — | — |
| EX-3 | 64.1% | 0.6% | 42.4% | 5.5% | — | — |
| EX-4 | 69.2% | 2.2% | 86.9% | 11.5% | — | — |
| EX-5 | 60.5% | 2.4% | 46.7% | 1.7% | — | — |
| EX-6 | 39.2% | 1.6% | 71.3% | 7.6% | 3.3% | 6.7% |
| EX-7 | 17.9% | 4.3% | 71.4% | 9.8% | — | — |
| EX-8 | 55.3% | 0.9% | 80.9% | 7.1% | — | — |
| EX-9 | 47.1% | 2.2% | 80.1% | 1.5% | — | — |
| EX-10 | 76.7% | 5.5% | 92.5% | 10.3% | — | — |
| EX-12A | 68.2% | 2.5% | 28.3% | 2.9% | — | — |
| EX-13A | 55.0% | 1.3% | 58.1% | 0.2% | — | — |
| EX-14 | 73.8% | 2.5% | 68.4% | 7.0% | 2.2 | 7.6 |

Several exemplary test cleaning formulas, as well as comparative sample CE-1, were evaluated individually in the Textile Cleaning Test. The measured Delta E values were as summarized in Table 8 (n=3).

TABLE 8

| Formula | Delta E | SD |
|---|---|---|
| Ex. 1 | 2.6 | 0.41 |
| Ex. 2A | 2.6 | 0.58 |
| Ex. 12A | 3.6 | 0.86 |
| Ex. 13A | 2.7 | 0.20 |
| CE-1 | 3.1 | 0.60 |

Several test cleaning formulas, as well as comparative sample CE-1, were evaluated individually in the Resoiling Test. The measured Delta E values were as summarized in Table 9A (with n=10 to 20).

TABLE 9A

| Formula | Delta E | SD |
|---|---|---|
| EX-1 | 4.8 | 0.34 |
| EX-2A | 4.8 | 0.79 |
| EX-12A | 4.4 | 0.56 |
| EX-13A | 3.8 | 0.41 |
| CE-1 | 13.2 | 6.57 |

In another experiment, pairs of test cleaning formulations were evaluated individually in the Resoiling Test, with the exception of subjecting carpet sample to foot traffic in a commercial setting for 4 days, rather than 12 days. As shown in Table 9B, each pair of test cleaning formulations (i.e., EX-2B and CE-2; EX-12B and CE-4; EX-13B and CE-5; and EX-11 and CE-3) had one test cleaning formulation that included the Stain blocker 1 component, and one test cleaning formulation that did not include the Stain blocker 1 component. The measured Delta E values were as summarized in Table 9B (with n=8).

TABLE 9B

| | Weight percent | | |
|---|---|---|---|
| Formula | Stain blocker 1 | Delta E | SD |
| EX-2B | 6 | 1.8 | 0.28 |
| CE-2 | 0 | 3.6 | 0.85 |
| EX-12B | 7 | 1.9 | 0.64 |
| CE-4 | 0 | 12.3 | 4.76 |
| EX-13B | 11.5 | 1.8 | 0.30 |
| CE-5 | 0 | 11.1 | 2.47 |
| EX-11 | 1.5 | 4.0 | 1.03 |
| CE-3 | 0 | 13.4 | 3.41 |

In Tables 9A and 9B, the formulas for EX-2A and EX-2B were identical, as were the formulas for EX-12A and EX-12B, as well as EX-13A and EX-13B.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An aqueous enzyme cleaning and protecting composition comprising:
water;
a protease;
a surfactant selected from an anionic surfactant, a nonionic surfactant, an amphoteric surfactant, and a combination thereof; and
a (meth)acrylic acid polymer component that is non-emulsifying;
wherein the composition demonstrates protease activity.

2. The composition of claim 1, wherein the composition demonstrates protease activity of at least 15% of a control.

3. The composition of claim 1, comprising at least two different enzymes of different classes of enzyme.

4. The composition of claim 3, further comprising an amylase, wherein the composition demonstrates amylase activity.

5. The composition of claim 4, wherein the composition demonstrates amylase activity of at least 15% of a control.

6. The composition of claim 3, further comprising a lipase, wherein the composition demonstrates lipase activity.

7. The composition of claim 6, wherein the composition demonstrates lipase activity of at least 10% of a control.

8. The composition of claim 1, wherein the surfactant is present in an amount of at least 0.1 wt-% of surfactant solids, based on the total weight of the composition.

9. The composition of claim 1, wherein the surfactant is present in an amount of up to 5 wt-% of surfactant solids, based on the total weight of the composition.

10-15. (canceled)

16. The composition of claim 1, comprising a mixture of surfactants.

17. The composition of claim 1, wherein the (meth)acrylic acid polymer component is present in an amount of at least 0.5 wt-% of polymer solids, based on the total weight of the composition.

18. The composition of claim 1, wherein the (meth)acrylic acid polymer component is present in an amount of up to 5 wt-% of polymer solids, based on the total weight of the composition.

19. The composition of claim 1, wherein the (meth)acrylic acid polymer component comprises a polymer having a weight average molecular weight of less than 1 million Da.

20. The composition of claim 1, wherein the (meth)acrylic acid polymer component comprises a polymer having monomeric units derived from a (meth)acrylic acid monomer and one or more ethylenically unsaturated comonomers.

21. The composition of claim 20, wherein the comonomers comprise an alkyl acrylate, a sulfated castor oil, sodium sulfostyrene, itaconic acid, a vinylidene monomer, a polyolefinic monomer, a heterocyclic monomer, a poly-carboxylic acid, a carboxylic acid ester, a carboxylic acid amide, a carboxylic acid nitrile, a carboxylic acid anhydride, or a mixture thereof.

22. The composition of claim 21, wherein the (meth)acrylic acid polymer component is derived from methacrylic acid, butyl acrylate, and a sulfated castor oil.

23. The composition of claim 1, comprising at least 50 wt-% water, based on the total weight of the composition.

24. An aqueous enzyme cleaning and protecting composition comprising:
water;
one or more enzymes comprising a protease and an amylase;
one or more surfactants selected from an anionic surfactant, a nonionic surfactant, an amphoteric surfactant, and a combination thereof; and
a non-emulsifying (meth)acrylic acid polymer component comprising a polymer having monomeric units derived from a (meth)acrylic acid monomer and one or more ethylenically unsaturated comonomers;
wherein the composition demonstrates protease activity; and
wherein the composition demonstrates amylase activity.

25. A method of cleaning and protecting a soiled textile, the method comprising:
applying a composition of claim 1 to the soiled textile; and
optionally, after a period of time, removing the composition from the textile.
